(19) United States
(12) Patent Application Publication
(10) Pub. No.: US 2014/0266210 A1
(43) Pub. Date: Sep. 18, 2014

(54) APPARATUS AND METHODS OF COMMUNICATION WITH WELLBORE EQUIPMENT

(71) Applicant: SENSOR DEVELOPMENTS AS, Sandefjord (NO)

(72) Inventor: ØIVIND GODAGER, Sandefjord (NO)

(73) Assignee: SENSOR DEVELOPMENTS AS, Sandefjord (NO)

(21) Appl. No.: 14/068,928

(22) Filed: Oct. 31, 2013

Related U.S. Application Data
(60) Provisional application No. 61/794,962, filed on Mar. 15, 2013.

(30) Foreign Application Priority Data
Apr. 30, 2013 (NO) 20130595

(51) Int. Cl. G01V 3/34

(52) U.S. Cl. CPC G01V 3/34
USPC 324/323; 340/854.8

(57) ABSTRACT

Apparatus and methods for acquiring data in a wellbore containing three or more casing or tubing strings through the use of inductive couplers to transmit power and signal through one or more fluid filled annular spaces and one or more casing or tubular elements.

### BACKGROUND OF THE INVENTION

### Field of the Invention

Embodiments of the present invention generally relate to a method and apparatus for acquiring data in a wellbore having three or more tubing and/or casing strings therein.

The management of oil and gas as well as storage type reservoirs constitutes an on-going concern of the petroleum industry. Those concerns are mainly due to the enormous monetary expenses involved in manufacturing and running any type of petroleum well as well as the risks associated with workovers and recompletions. Herein, a petroleum type well is defined as any type well being drilled and equipped for the purpose of producing or storage of hydrocarbon fractures from or to subsurface formations. Further, petroleum type wells are categorized as any of or combination, storage, observation, producing or injection type wells.

Modern reservoir management systems more and more look into the advancement of including measurements from outside of the wellbore casing.

Measurements close as well as far from the wellbore are being considered.

Thus the prospect and purpose of formation parameter monitoring has become more complex than was previously the case. As with the industry in general, the motivation is to fully understand the physical properties and geometry of the reservoir as this in the long-term contributes to extending the lifetime of the well as well as production yields.

There are numerous formation parameters that may be of interest when having sensor technology available for looking into the formation side of the casing as in the present invention. Thus, the sensor measurement technology proposed applies to any type formation measurements such as, for example, resistivity, multi-axes seismic, radiation, pressure, temperature, chemical means, to mention a few.

Modern wellbores have several annuli outside the production tubing. The first annulus outside the production tubing is usually termed the A-annulus, then outside the A annulus is a new tubing or casing surrounded by the B-annulus. Some wells may have up 5 annuli, i.e. A, B, C, D and E. The pressure and temperature inside the annuli may have impact on the operation of the well, and such parameters may therefore be directly used as feedback parameters to the control systems for production.

For safety and reliability reasons, at least one of the tubings outside the production tubing, e.g., the tubing between the A and B annulus, act as a wellbore barrier. Thus, openings and passageways in this tubing for communication cables etc. should be avoided to maintain the integrity of the barrier.

With advancements in drilling and completion techniques, it is not uncommon for multiple tubular strings to be used in the wellbore in an overlapping manner and multiple annular areas to be formed therebetween, some or all of which include parameters needing to be measured and monitored from the surface, in addition to parameters in the formation surrounding the wellbore.

What is needed is an improved method and apparatus of measuring and communicating wellbore parameters in wellbores with at least three tubular strings disposed within one another and forming annuli therebetween.

### SUMMARY OF THE INVENTION

The present invention generally includes apparatus and methods for acquiring data in a wellbore containing three or more casing or tubing strings through the use of inductive couplers to transmit power and signal through one or more fluid filled annular spaces and one or more casing or tubular elements.

In one embodiment, downhole wireless communication systems are used to monitor various downhole aspects/parameters and communicate information related to those aspects to other areas of the well, like the surface. In some cases, power and information run along on a first tubular string in the form of a cable. At a lower portion of the cable, a first inductive coupler or “antenna” transmits the power/information to a second inductive coupler or “antenna” in a wellbore. In some instances, the second inductive coupler is disposed on a second tubular string outside the first tubular string and in some cases, it is coaxially disposed within the first tubular string. Such wireless communication facilitates the measurement of parameters external to the first inductive coupler without the use of conductors or apertures in the first and second tubulars that can affect the integrity of areas intended to be isolated from one another.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a first embodiment shown in section view of a wellbore with an inner tubular string, an intermediate tubular string and an outer tubular string disposed therein with annular areas formed therebetween.

FIG. 2 and FIG. 3 are another embodiment shown in various section views of the wellbore with the inner tubular string, the intermediate tubular string and the outer tubular string and an external tubing string disposed therein with annular areas formed therebetween.

FIGS. 4a-4d illustrate different possible configurations of sensors and inductive couplers on tubular strings of a wellbore according to various embodiments.

FIG. 5 illustrates a partial cross-sectional view of a wellbore with four tubular strings with a configuration of sensors and inductive couplers arranged thereon according to at least one embodiment.

FIG. 6 illustrates a partial cross-sectional view of a wellbore with four tubular strings with a configuration of sensors and inductive couplers arranged thereon according to at least one embodiment.

FIG. 7 illustrates a partial cross-sectional view of a wellbore with three tubular strings with a configuration of sensors and inductive couplers arranged thereon according to at least one embodiment.

### DETAILED DESCRIPTION

The present invention is related to downhole wireless communication between multiple tubular strings with multiple annular areas therebetween. More particularly, the invention relates to a method and apparatus to accurately monitor in-situ the pressure and/or temperature or other parameters in one or more well casing annuli without compromising the integrity of the well or well design in any way. Downhole communication between wellbore strings is discussed in U.S. Pat. Nos. 5,008,664 and 8,469,084, European Patent Nos. EP 2 389 498 B1 and EP 2 386 011 B1, as well as International publication No. WO/2012/018322 A1, and those documents are all incorporated by reference herein in their entirety.

Wellbore barriers are often needed to comply with new regulations and to provide a degree of reliability for complex installations both in petroleum industry and in other industries (e.g., storing of nuclear waste). With the introduction of multi-annuli wells and wellbore barriers, the demand for flexible monitoring of both formation parameters and annuli parameters across wellbore barriers has increased.

FIG. 1 is a first embodiment shown in a wellbore 150 and includes an inner tubular string 100, an intermediate tubular string 200, and an outer tubular string 300 with annular areas A, B formed therebetween. The annular areas A, B may be filled with liquid in the form of water, drilling fluid, curable material, hydrocarbons and/or gas. In the example shown, the inner tubular string 100 is production tubing, the intermediate tubular string 200 is liner and the outer tubular string 300 is casing that is retained in the wellbore 150 with cement 160. While FIG. 1 features tubular strings 100, 200, 300 in the form of production tubing, liner and casing, it will be understood that the invention is not limited to any particular types of tubing, tubing strings, or arrangements therebetween and aspects of the invention are equally usable no matter how or where the tubings are used in a wellbore, so long as there are annuli formed between them.

The inner tubular string 100 includes a section 101 that is installed in the inner tubular string 100 using threaded connections 103 at an upper and lower end and includes a first annularly shaped inductive coupler (antenna) 400 mounted thereon. Section 101 is made of any of the various types of tube materials known to those skilled in the art that will not adversely affect communications between the first inductive coupler 400 and a second inductive coupler 500 on the outer tubular string 300. The first inductive coupler 400 includes a sensor energizer unit (not shown) adapted to host a wireless sensor 401. In a typical arrangement, an electromagnetic armature provides both a power source and communications link for the sensor energizer unit. The principal transmission of the electromagnetic armature is by low frequency induction or electromagnetic (EM) means, which is picked up and converted to electric energy by the sensing energizer unit. A control cable 402 is attached to the electromagnetic armature and to the inner tubular string 100 by traditional cable clamps and exits the well through the wellhead (not shown). Typically, the control cable 402 is a single-conductor tubing electric cable type, providing power to the sensing energizer unit and capable of transmitting information in two directions.

In the example shown in FIG. 1, the intermediate tubing 200 has been “hung” off the outer tubular string 300 at liner hanger 410 which seals the upper end of annulus B. At a lower end, annulus B is sealed due to cementing of the intermediate tubing 200 in the wellbore adjacent a casing shoe 420. In this manner, annulus B, formed between intermediate and outer string 200, 300, is isolated from annulus A. The intermediate tubing 200 includes an upper section 201 constructed of non-magnetic material or other material having a low magnetic permeability. Examples of non-magnetic and/or low magnetic materials include, but are not limited to, 316 stainless steel non-magnetic, INCONEL 718 alloy, MP 35N, INCONEL 825 alloy, and 25 Cr super duplex. In the embodiment shown, the inner tubing section 101 is axially adjustable relative to the intermediate section with threaded connections 103 in order to facilitate alignment of the components.

The outer tubular string 300 includes second inductive coupler 500 constructed and arranged to provide communication to the first inductive coupler 400 located on the inner tubular string 100. Like the inner tubular string 100, the second inductive coupler 500 is located in a section 301 made of any of the various types of tube materials known to those skilled in the art and installed in the outer tubular string 300 with threaded connections.

The arrangement of the components in FIG. 1 illustrates the possibility of transmitting information from an area of the wellbore 150 outside annulus A, across that annulus A in a non-intrusive manner, thus ensuring the integrity of annulus A. In the embodiment shown, the components are arranged to gather information related to temperature and pressure, for example, in annulus B proximate the casing shoe 420. A wireless sensor 501 installed in a housing with the second inductive coupler 500, measures temperature and pressure, for example in annulus B and thereafter, the information is transmitted from the second inductive coupler 500 to the first inductive coupler 400 and travels in the control cable 402 to the surface of the well.

While not shown in FIG. 1, it is possible to provide a port through a wall of the outer tubular string 300 to allow sensor access to an environment outside an OD of the outer tubular string 300. It is also possible to place sensors directly on the OD of the outer tubular string 300 which are electrically connected to the second inductive coupler 500 via an electrical conductor which passes through the wall of the outer tubular string 300. Pressure integrity may be maintained by the use of an electrical feed-through which is designed for this purpose.

The arrangement shown in FIG. 1 is installed in the wellbore 150 in the following manner: After a first section of wellbore 150 is drilled, the outer tubular string 300 is run into the wellbore 150 with the casing shoe 420 at the lower end and including section 301 with the second inductive coupler 500, wireless sensors 501, and any ports leading to an outer formation area. Thereafter, a second, smaller diameter section of wellbore 150 is drilled, and the intermediate tubular string 200 is run in and hung off the outer tubular string 300 with the liner hanger 410. Intermediate tubular string 200 is equipped with section 201 and in wellbore 150, is located adjacent section 301 of outer tubular string 300. After cementing the intermediate tubular string 200, annulus B is sealed at the upper end by the liner hanger 410 and at an area proximate the casing shoe 420. At some later time when the well is completed, the inner tubular string 100 is run into the wellbore 150 with the section 101 arranged to make the first inductive coupler 400 adjacent the second inductive coupler 500, thereby forming annulus A between inner 100 and intermediate 200 tubular strings. With all parts in place, pressure/temperature (or other parameters) in isolated annulus A can be measured, and pressure/temperature can be measured in annulus B and transmitted wirelessly across annulus A without threatening the integrity of annulus B.

FIGS. 2 and 3 are section views of the wellbore illustrating another arrangement by which parameters of an annulus are measured and information is transmitted across an intermediate annulus in a non-invasive manner. In FIGS. 2 and 3, three annular areas A, B, C are formed between four tubular strings 100, 200, 300, 600. The wellbore components are similar to those in FIG. 1 with the addition of an exterior casing 600 that forms annulus C between itself and outer tubular string 300. As before, inner tubular string 100 is typically completion tubing and includes first inductive coupler 400 mounted in section 101 of the inner tubular string 100 and having means, in the form of a cable 402, to transmit information to a higher location in the wellbore. The second inductive coupler 500 is installed in the outer tubular string 300, and wireless pressure and temperature sensors are located adjacent first inductive coupler 400 (401) and second inductive coupler 500 (501, 503). Wireless sensor 401 associated with the first inductive coupler 400 provides means to monitor annulus A. The second wireless sensor 501 is arranged to monitor annulus B, and wireless sensor 503 is constructed and arranged to monitor annulus C through the use of a fluid port 502 that places the sensor 503 in fluid communication with annulus C. In this manner, pressure and temperature are monitored in annulus C and transmitted across annulus B (which might be a barrier annulus) in a non-intrusive/invasive manner. While the embodiment of FIGS. 2 and 3 includes the monitoring of three annuli A, B, C, it will be appreciated that any number of annuli could be monitored using the apparatus and method of the invention, and it is not limited to the embodiments shown.

In various embodiments, sensing elements (e.g. temperature and/or pressure, for example) can be placed on the same wall of the tubular string as the inductive coupler. In this manner, the sensor element and the coupler can share common pressure housing. For example, as shown in the Figures, the wireless temperature and pressure sensor may be included in the housing for the first inductive coupler 400, and fixed to the OD of the inner tubular string 100 (e.g. the production tubing). These sensors monitor properties of the environment in the annulus A between the inner 100 and intermediate 200 tubular strings. In this instance, the sensors can be powered via the first inductive coupler 400 and may communicate via a port leading to an interior of the tubing to monitor parameters of the fluid (like production fluid) therein. As shown in FIG. 1, it is also possible to locate sensor elements adjacent to the second inductive coupler 500. In these instances, the sensors receive power and transmit signal via the second inductive coupler 500. In this example, properties of the environment in the annulus between the outer tubular string 300 and the intermediate tubular string 200 are monitored (annulus A, FIG. 1).

Referring now to FIGS. 4a-4d, it is also possible to provide access through the wall of a tubular string to allow a sensor access to a side of the tubing opposite from the inductive coupler. For example, referring to FIG. 4a, the second inductive coupler 500 can be arranged on an inner wall of the outer tubular string 300. A sensor 504 can be arranged on an outer wall of the outer tubular string 300. The sensor 504 can be connected to the second inductive coupler 500 via a communication link 505. In various embodiments, the communication link 505 can comprise one or more wires or cables that provide for communication of sensor measurements from the sensor 505 to the second inductive coupler 500 such that the second inductive coupler 500 can communicate the sensor measurements to the first inductive coupler 400 and the control cable 402. The communication link 505 can pass through an orifice (e.g., a port, such as port 502 shown in FIG. 2) in the outer tubular string 300. The orifice may be sealed with a sealant to isolate annulus B from the environment outside of the outer tubular string 300. In various embodiments, the communication link 505 can comprise a wireless link.

FIGS. 4b-4d illustrate various embodiments that include different possible arrangements of sensors and inductive couplers on walls of tubing strings. FIG. 4b illustrates the second inductive coupler 500 on an inner wall of the outer tubular string 300 and the sensor 504 arranged on an outer wall of the outer tubular string 300. FIG. 4b also illustrates the first inductive coupler 400 on an outer wall of the inner tubular string 100 with a sensor 401 also located on the outer wall of the inner tubular string 100. In the embodiment shown in FIG. 4b, a control cable 403 passes through wall of the inner tubular string 100 (e.g., through an orifice) to travel through an inner diameter of the string 100. The embodiment shown in FIG. 4c is similar to the embodiment shown in FIG. 4b, except the control cable 402 remains on the outer wall of the inner tubular string 100 as the first inductive coupler 400.

The embodiment shown in FIG. 4d is similar to the embodiment shown in FIG. 4c, except the inductive couplers 400 and 500 each have two sensors. The first inductive coupler 400, arranged on an outer wall of the inner tubular string 100, is in communication with a sensor 401 that is also arranged on the outer wall of the inner tubular string 100. The first inductive coupler 400 is also in communication with a sensor 404 that is arranged on the inner wall of the inner tubular string 100. The sensor 404 can be coupled to the first inductive coupler 400 via a communication link 405. The second inductive coupler 500, arranged on an inner wall of the outer tubular string 300, is in communication with a sensor 501 that is also arranged on the inner wall of the outer tubular string 300. The second inductive coupler 500 is also in communication with a sensor 504 that is arranged on an outer wall of the outer tubular string 300. The sensor 504 can be coupled to the second inductive coupler 500 via a communication link 505.

Referring again to FIG. 2, a significant benefit of the system described above is that it can provide a means of making measurements on either side of a tubular string while maintaining a primary barrier (tubing string) which is free of penetrations having a potential to become leak paths. Such a system may consist of a first inductive coupler attached to the OD of an inner tubular string, wherein the first inductive coupler is located in the well at a position below a liner hanger for an intermediate tubular string and above the shoe of an outer tubular string. A second inductive coupler may be located in the ID of the outer tubular string at a depth between the liner hanger of the intermediate tubular string and the shoe of the outer tubular string such that the first and second inductive couplers are located at essentially the same depth in the well. The outer tubular string may have a penetration (see port 502, FIG. 2) by which a sensor 503 may access and monitor the environment outside of the outer tubular string, thus allowing for the measurement of pressure in the seal rock above the shoe and below the liner hanger.

The intermediate and outer tubular strings may be cemented in place such that a potential leak path provided by the penetration is isolated from the surface by the intermediate tubular string which is sealed at the liner hanger and is cemented in place. As described above, a section of the intermediate tubular string, which is at essentially the same depth as the first and second inductive couplers, may be constructed of a material of low magnetic permeability.

As described above with respect to FIGS. 4a-4d, sensors may be placed on both sides of a tubing section to which the inductive couplers are attached. This enables measurement of parameters in multiple annuli by each instrument device while allowing an unpenetrated intermediate tubular string for assurance of pressure integrity. In one aspect, formation pressure/temperature are monitored by a wireless sensor either placed on an OD of an outer tubular string or via a port formed in a wall of the outer tubular string. Information relating to the formation can then be transmitted across a barrier annulus as taught above.

While the cable is shown extending from the inner casing, it will be understood that the cable could be supported and carried by any other tubular string that includes a coupler. For example, in another embodiment an electrical conductor is run in the annulus between the intermediate and outer tubular strings and supplies power to a second inductive coupler. Power and signal may be transmitted through the annulus between the second inductive coupler and OD of the intermediate tubular string, through the intermediate tubular string, and through the annulus between the intermediate tubular string and the first inductive coupler. In yet another possibility, an electrical conductor is run along the OD of the outer tubular strings and supplies power to the second inductive coupler. Power and signal may be transmitted through the annulus between the second inductive coupler and OD of the intermediate tubular string, through the intermediate tubular string, and through the annulus between the intermediate tubular string and the first inductive coupler.

FIG. 5 illustrates an embodiment of a wellbore in which parameters of an annulus are measured and information is transmitted across an intermediate annulus in a non-invasive manner. In FIG. 5, three annular areas A, B, and C are formed between a first tubular string 720 (e.g., an intermediate tubular string), a second tubular string 820 (e.g., a second intermediate tubular string), and a third tubular string 920 (e.g. a casing). Annular area A is formed between the first tubular string 720 and the second tubular string 820. Similarly, annular area B is formed between the second tubular string 820 and the third tubular string 920. A third annular area C is formed between the third tubular string 920 and an external casing 1000. The annular areas may be filled with liquids or gases, including, but not limited to, water, drilling fluid, curable material, and/or hydrocarbons. In certain embodiments, the first tubular string 720 can be production tubing 700, the second tubular string 820 can be a liner 800, and the third tubular string 920 can be casing 900. The first tubular string 720 can be completion tubing and can include a first wellbore instrument 708 that includes a first inductive coupler 706 and a sensor 702. The sensor 702 (e.g., a pressure sensor and/or a temperature sensor) can be arranged proximate to the first tubular string 720 to monitor parameters in annular area A. A second wellbore instrument 908, including a second inductive coupler 906 and a sensor 902, can be arranged on an inner wall of the third tubular string 920. The sensor 902 can be arranged proximate to the third tubular string 920. The sensor 902 can be arranged in communication with port 904 such that the sensor 902 can monitor parameters in annular area C. Data from sensor 902 can be transmitted across annular area B to the first wellbore instrument 708 and transmitted via the control cable 704 to the surface. The data from sensor 902 can be transmitted across the annular area B in a non-intrusive and/or non-invasive manner.

In various embodiments, sensors can be placed on the same wall of a tubular string as the inductive coupler. In such embodiments, the sensor and the inductive coupler can share a common pressure housing. For example, as shown above in FIG. 5, the sensor 702 and inductive coupler 706 can share a common housing. Similarly, sensor 902 and inductive coupler 906 can share a common housing.

While not shown, it is possible to provide access to the inner wall of the inner tubular string 720 to enable sensor access to the inner diameter of the tubular string 720. For example, the inner tubular string 720 may include a port, similar to port 904, such that sensor 702 can monitor parameters (e.g., pressure and/or temperature) within the inner diameter of the inner tubular string 720.

FIG. 6 is also a section view of a wellbore illustrating an embodiment by which parameters of an annulus are measured and information is transmitted across an intermediate annulus in a non-invasive manner. In FIG. 3, three annular areas A, B, C are formed in a wellbore between an inner tubular string 700, a third tubular string 820 (e.g. an intermediate tubular string), a second tubular string 920 (e.g., a second intermediate tubular string), and a first tubular string 1020 (e.g., a casing. In this embodiment, parameters are measured in annular area A and transferred to a control cable 1010 running through annular area D to the surface. Thus, the transfer direction of the measured values in this embodiment is opposite the transfer direction in the embodiment shown in FIG. 3, where the cable was running along the production tubing and the pressure/temperature sensor 802 was located in annular area C.

The outer first tubular section 1020 is typically casing and can include a first inductive coupler 1006. The second inductive coupler 806 is installed in the first intermediate tubing 800. The sensor 802 is arranged to monitor annular area A. The sensor 802 may also be located on the outer diameter of the third tubular section 820 and make use of a fluid port that places the sensor in fluid communication with annular area C. In this manner, pressure and temperature, for example, are monitored in annular area C and transmitted across annular area B (which might be a barrier annulus) in a non-intrusive/invasive manner. While the embodiment shown in FIG. 6 includes the monitoring of two annuli, it will be appreciated that any number annuli could be monitored using the apparatus and method of the invention and it is not limited to the embodiments shown.

FIG. 7 is an embodiment shown in a wellbore and includes a first tubular section 720, an intermediate second tubular section 820, and an outer third tubular section 920 with annular areas A and B formed there between. The annular areas may be filled with liquid in the form of water, drilling fluid, curable material, hydrocarbons and/or gas. In the example shown, the first tubular section 720 is production tubing, the second tubular section 820 is liner, and the third tubular section 920 is casing that is retained in the wellbore with cement 160. While FIG. 7 features tubular strings in the form of production tubing, liner and casing, it will be understood that the invention is not limited to any particular types of tubing, tubing strings, or arrangements therebetween and aspects of the invention are equally usable no matter how or where the tubings are used in a wellbore, so long as there are annuli formed between them.

The first tubular section 720 includes a section 701 that is installed in the string using threaded connections 702 at an upper and lower ends and includes a first annularly shaped inductive coupler (e.g., antenna) 706 mounted thereon. The coupler 706 includes a sensor energizer unit (not shown) adapted to host a wireless sensor (such as sensor 702 shown in FIG. 5). In a typical arrangement, an electromagnetic armature provides both a power source and communications link for the sensor unit. The principal transmission of the armature is by low frequency induction or electromagnetic (EM) means, which is picked up and converted to electric energy by the sensing unit. A control cable 704 is attached to the armature and to the first tubular section 720 by traditional cable clamps and exits the well through the wellhead (not shown). Typically, the control cable 704 is a single-conductor tubing electric cable type, providing power to the sensing unit and capable of transmitting information in two directions.

In the example shown in FIG. 7, the second tubular section 820 has been “hung” off the third tubular section 920 at liner hanger 810 which seals the upper end of annular area B. At a lower end, annular area B is sealed due to cementing of the second tubular section 820 in the wellbore adjacent a casing shoe 420. In this manner, annular area B, formed between the intermediate string 800 and the outer string 900, is isolated from annular area A. Like first tubular section 720, the second tubular section 820 includes an upper section 801 constructed of non-metallic or other material having a low magnetic permeability. In the embodiment shown, the inner tubing section 701 is axially adjustable relative to the intermediate section with threaded connections 102. The third tubular section 920 includes a second inductive coupler 906 constructed and arranged to provide communication to the coupler 706 located on the first tubular section 720. The section 901 is installed at a lower end of the string to ensure it will be proximate a casing shoe 420 therebelow and the intersection of the casing and the intermediate string.

The arrangement of the components in FIG. 7 illustrate the possibility of transmitting information from an area of the wellbore outside annular area A across that annulus in a non-intrusive manner, thus ensuring the integrity of annular area A. In the embodiment shown, the components are arranged to gather information related to temperature and pressure, for example, in annular area B proximate the casing shoe 420. A sensor 902 installed in a housing with the second inductive coupler 906, measures temperature and pressure, for example, in annular area B and thereafter, the information is transmitted from the second coupler 906 to the first coupler 706 and travels in the control cable 704 to the surface of the well.

While not shown in FIG. 7, it is possible to provide a port through the wall of the outer tubing to allow sensor access to the environment outside the OD of an outer casing string. It is also possible to place sensors directly on the OD of the outer casing string which are electrically connected to the second inductive coupler via an electrical conductor which passes through the penetration through the wall of the outer casing string. Pressure integrity may be maintained by the use of an electrical feed-through which is designed for this purpose.

The arrangement shown in FIG. 7 is installed in a wellbore in the following manner: After a first section of wellbore is drilled, the third tubular section 920 is run into the well with a casing shoe 420 at a lower end and including section 901 with the inductive coupler 906, sensors 904, and any ports leading to an outer formation area. Thereafter, a second smaller-diameter section of wellbore is drilled and the second tubular section 820 is run in and hung off the third tubular section 920 with a liner hanger 810. Second tubular section 820 is equipped with nonmagnetic section 801 and, in the wellbore, is located adjacent section 901 of outer tubular string 900. After cementing second tubular section 820, annular area B is sealed at an upper end by the sealing liner hanger 810 and at an area proximate the casing shoe 420. At some later time when the well is completed, the first tubular section 720 is run into the wellbore with the inner tubing section 701 arranged to make the first inductive coupler 706 adjacent the second inductive coupler 906, thereby forming annular area A between first tubular section 720 and second tubular section 820. With all parts in place, pressure and/or temperature, for example, in isolated annular area A can be measured and pressure and/or temperature, for example, can be measured in annular area B and transmitted wirelessly across annular area A without threatening the integrity of the sealed annulus.

While the foregoing is directed to embodiments of the present invention, other and further embodiments of the invention may be devised without departing from the basic scope thereof, and the scope thereof is determined by the claims that follow.

1. A tool for use in a wellbore, comprising:
an inner tubular having a first inductive coupler disposed on an outer surface thereof;
an intermediate tubular coaxially disposed around the inner tubular and forming a first annulus therebetween;
an outer tubular coaxially disposed around the intermediate tubular and forming a second annulus therebetween;
a second inductive coupler disposed on an inner surface of the outer tubular;
a cable extendable from the first inductive coupler to another location in the wellbore, the cable for providing power to the first inductive coupler and for transmitting data to the other location; whereby
wireless communication of data takes place between the first inductive coupler and the second inductive coupler.

2. The tool of claim 1, including a first sensor disposed adjacent the first inductive coupler for measuring wellbore parameters in the first annulus.

3. The tool of claim 2, including a second sensor disposed adjacent the second inductive coupler for measuring wellbore parameters in the second annulus.

4. The tool of claim 1, wherein the first tubular is production tubing and the second tubular is liner.

5. The tool of claim 4, wherein the second annulus is a sealed annulus sealed by a packer at an upper end and by a cement shoe at a lower end.

6. The tool of claim 1, further including a sensor disposed on an outer surface of the outer tubular and in communication with the second inductive coupler via a port formed through a wall of the outer tubular.

7. The tool of claim 1, further comprising a sensor disposed on an inner surface of the inner tubular and in communication with the first inductive coupler via a port formed through a wall of the inner tubular.

8. The tool of claim 1, further comprising a sensor disposed on an outer surface of the inner tubular and in communication with the first inductive coupler, wherein the sensor measures an attribute of an inner volume within the inner tubular via a port formed through a wall of the inner tubular.

9. The tool of claim 1, further comprising a sensor disposed on an inner surface of the outer tubular and in communication with the second inductive coupler, wherein the sensor measures an attribute of an outer volume outside of the outer tubular via a port formed through a wall of the outer tubular.

10. The tool of claim 1, wherein the cable is extendable from the first inductive coupler to the surface of the wellbore.

11. A tool for use in a wellbore, comprising:
an inner tubular;
a first inductive coupler disposed on an outer surface of the inner tubular;
a first sensor for measuring parameters in a first annulus;
an intermediate tubular coaxially disposed around the inner tubular and forming the first annulus therebetween;
an outer tubular coaxially disposed around the intermediate tubular and forming a second annulus therebetween;
a second inductive coupler disposed on an inner surface of the outer tubular;
a second sensor disposed on an inner surface of the outer tubular for measuring parameters in the second annulus;
a third sensor disposed on an interior surface of the outer tubular for measuring parameters in an exterior annulus defined between the outer tubular and an exterior tubular therearound, the exterior annulus formed therebetween;
a cable extendable from the tool to another location in the wellbore, the cable for providing power to the tool and for transmitting data to the other location wherein;
the intermediate tubular is non-magnetic and communication between the inductive couplers is wireless communication.

12. The tool of claim 11, wherein the tool is constructed and arranged to be installed in a string of wellbore tubulars.

13. The tool of claim 12, wherein the first and second annuli are filled with fluid.

14. The tool of claim 11, wherein data comprise at least one of pressure and temperature.

15. The tool of claim 11, wherein the third sensor is in fluid communication with the exterior annulus.

16. The tool of claim 11, wherein the inner tubular carries production fluid.

17. The tool of claim 16, wherein the exterior tubing is wellbore casing.

18. The tool of claim 17, wherein the wellbore casing is cemented in the wellbore.

19. A method of gathering wellbore data, comprising:
forming a first annulus between a first tubular and a second tubular therearound;
forming a second annulus between the second tubular and a third tubular therearound;
providing a sensor in communication with the second annulus; and
transmitting data gathered by the sensor between the first and second annulus.

20. The method of claim 16, further including forming a third annulus between the third and a fourth tubular;
providing a sensor in the third annulus;
transmitting data gathered by the sensor in the third annulus between the third annulus and first annulus.
